(19) United States
(12) Patent Application Publication
(10) Pub. No.: US 2004/0113483 A1
(43) Pub. Date: Jun. 17, 2004

(54) Method of adhering decorative wheel cover to automobile wheel

(76) Inventors: Michael S. Sylvester, Bratenahl, OH (US); Brian R. Chambers, Mantua, OH (US); Craig Scott Strachan, Lakewood, OH (US)

Correspondence Address: PEARNE & GORDON LLP, 1801 EAST 9TH STREET, SUITE 1200, CLEVELAND, OH, 44114-3108, US

(21) Appl. No.: 10/316,525

(22) Filed: Dec. 11, 2002

(51) Int. Cl. B60B 7/00

(52) U.S. Cl. 301/37.11

(57) ABSTRACT

A method of applying a decorative wheel cover to a wheel rim is provided. An uncured precursor composition having a quantity of spacer particles therein is applied to the rear face of the wheel cover or an outboard surface of the wheel rim, and the wheel cover and rim are then press-fit together, sandwiching the precursor composition therebetween. The precursor composition is preferably a moisture-cured silicone composition. The wheel cover is press-fit to the wheel rim until further compression is prevented due to the presence of the spacer particles. The resulting precursor composition layer has a uniform thickness and is cured to provide an adhesive layer having the corresponding uniform thickness. A kit for practicing the method, as well as a wheel are also provided.

### BACKGROUND OF THE INVENTION

1. Field of the Invention

The invention relates generally to automobile wheels having a decorative overlay or wheel cover. More particularly, this invention relates to a method for securing such an overlay or wheel cover to an automobile wheel to provide a strong, reliable bond therebetween.

2. Description of Related Art

Decorative wheel rims (e.g. chrome-plated rims) for automobiles have been popular for many years. When available as an option on new automobiles, chrome plated rims can increase the new purchase price of the vehicle by several hundred dollars or more. As an after-market option, standard wheel rims can be chrome plated at significant expense, e.g., for about $400-500 per wheel rim. The result is that chrome plated wheels, both as an OEM (original equipment manufacturer) vehicle option and as an after-market option, can be cost prohibitive for many consumers. Thus, there is a relatively large demand in the automotive industry for methods of providing a chrome plated or other decorative finish or appearance to standard wheel rims at a reasonable or affordable cost.

Decorative overlays or wheel covers have been widely used for this purpose. The wheel cover is provided with a chrome plated appearance (real or simulated), and then adhered to the standard wheel to enhance the aesthetic appearance of the wheel. Wheel covers can be used to simulate a chrome or chromium plated finish on standard steel wheels, as well as on cast aluminum wheels where true chrome plating may not be feasible due to the poor adherence of chromium to aluminum and high cost. Alternatively, other decorative patterns besides chrome plating can be provided to the wheel covers.

Numerous methods for attaching the wheel covers to standard steel or cast wheels are known. Many wheel covers are mechanically attached, for example, via fasteners provided on the wheel cover which are adapted to secure the wheel cover to the wheel hub or rim. For example, screws and bolts are known, but not preferred due to the tendency for galvanic corrosion between dissimilar metals. Clamps, spring clips and other mechanical fasteners are also known. Still other wheel covers are adhered to the outboard surface of the wheel rim using double-sided adhesive tape as taught in U.S. Pat. No. 3,915,502.

The above-described methods suffer from the drawback that they all employ mechanical fasteners or a pressure sensitive adhesive (PSA) to adhere the wheel cover to the wheel. Unfortunately, the surface of an automobile wheel rim is a torturous environment for mechanical fasteners and PSAs. The wheels experience constant, often vigorous or violent vibration and shock. One inopportunely placed pothole, even at low or moderate vehicle speed, can cause failure of most mechanical fasteners stripping the wheel cover from the wheel. PSAs such as those employed on double-sided adhesive tape also are prone to failure in this application due to thermal cycling from road friction, tire expansion and contraction, and the changing seasons.

One solution has been to provide a layer of uncured polymeric foam or silicone material between the wheel cover and the wheel rim, and allow the foam or silicone material to cure in-situ thus forming a silicone or foam adhesive layer with a very strong bond at both interfaces; i.e. at the layer-rim interface and at the layer-wheel cover interface.

U.S. Pat. Nos. 5,188,428, 5,297,854, 5,595,423, 5,597,213, 5,630,654, 5,845,973, 6,022,081, 6,082,829, 6,200,411, and 6,346,159 are exemplary of the state of the art and are incorporated herein by reference.

Polymeric foam/silicone adhesive layers have been fairly successful when installed or provided by OEMs to adhere wheel covers to wheel rims. This is because OEMs employ automated equipment and trained personnel that are capable of applying the appropriate amount of the uncured foam or silicone composition to the rim or wheel cover surface, and of uniformly applying the right amount of pressure when attaching the wheel cover to the rim. However, faced with problems of imperfect tolerancing of uniformity of the thickness of the adhesive layer, OEM applications often require or provide for excess uncured composition so that sufficient material remains to provide an approximately uniform layer thickness once the wheel cover is press-fit to the wheel rim. This excess material is simply squeezed out from between the wheel cover and the rim as waste, contributing to added cost and environmental pollution.

After-market applications have met with less success. Often, automobile owners wish to attach decorative wheel covers to wheel rims themselves. These owners are mostly untrained persons who are unskilled in the art of foam or silicone layer application, curing and adhesion. It is difficult, if not impossible, for an unskilled layperson to know exactly how much pressure to exert when attaching the wheel cover to the rim with the uncured silicone composition in between. The result is the layperson almost invariably exerts too much pressure and squeezes too much of the uncured material out from between the wheel cover and the rim. Consequently, when the silicone or foam material cures, the resulting layer has insufficient thickness to provide adequate bond strength, and the adhesive layer ultimately fails.

Also, a layperson almost always does not apply uniform pressure over the entire surface of the wheel cover when adhering it to the wheel rim. This results in nonuniform thickness of the uncured material layer between the wheel cover and the rim. When the material cures, the resulting adhesive layer has a correspondingly nonuniform thickness which can lead to stress points along the layer surface that can fail under an impact load, as may result from a bumpy road or a pothole.

By and large, the result of lay-applied wheel covers using in-situ curing foam or silicone adhesive layers has been failure of the adhesive layer due to too excessive and/or nonuniform pressure being applied to adhere the wheel cover to the wheel rim before the silicone or foam material has cured.

Accordingly, there is a need in the art for a method of applying a wheel cover to a wheel rim using an in-situ curing adhesive layer, such as a silicone or foam adhesive layer, that can be reproducibly performed by laypersons to achieve a strong, reliable bond. Preferably, such a method will result in a substantially uniform cured adhesive layer having the desired thickness in a manner that does not depend on the layperson's skill level. Also preferably, such a method will provide for more efficient automated application of the adhesive layer to the wheel rim or the wheel cover, so that the use of excessive material can be prevented or substantially minimized.

### SUMMARY OF THE INVENTION

A method of applying a decorative wheel cover to a wheel rim is provided. The method includes the following steps: a) providing an uncured precursor composition that has a quantity of spacer particles dispersed therein; b) applying the uncured precursor composition to a rear face of the wheel cover or to an outboard surface of the wheel rim, or to both; c) applying the wheel cover to the wheel rim such that a layer of the uncured precursor composition is sandwiched in a gap between the wheel cover and the wheel rim; d) press-fitting the wheel cover to the wheel rim until the gap therebetween is reduced to substantially the diameter of the spacer particles, thereby reducing the precursor composition layer to a final thickness that is substantially equal to the diameter of the spacer particles; and e) curing the precursor composition layer to form a cured adhesive layer disposed between the wheel rim and the wheel cover.

A kit is also provided that includes a decorative wheel cover and an uncured precursor composition. The decorative wheel cover is adapted to be applied to a wheel rim. The uncured precursor composition has a quantity of spacer particles dispersed therein. The uncured precursor composition is curable to form a cured adhesive layer between the decorative wheel cover and said wheel rim that is effective to retain the wheel cover on the wheel rim.

An automobile wheel is also provided. The wheel has a wheel rim and a decorative wheel cover adhered to the wheel rim via a cured adhesive layer disposed therebetween. The cured adhesive layer has a quantity of spacer particles therein. The cured adhesive layer has an adhesive layer thickness that is substantially equal to the diameter of the spacer particles.

A method of applying a decorative wheel cover to a wheel rim via a foam adhesive layer is also provided. The method includes the following steps: a) providing an uncured silicone precursor composition that has a quantity of spacer particles dispersed therein; b) applying the precursor composition to a rear face of the wheel cover or to an outboard surface of the wheel rim, or both, wherein the precursor composition is applied in a bead surrounding an opening or structure into or adjacent to which foam expansion is to be avoided; c) applying the wheel cover to the wheel rim such that the bead of precursor composition is sandwiched in a gap between the wheel cover and the wheel rim; d) press-fitting the wheel cover to the wheel rim until the gap therebetween is reduced to substantially the diameter of the spacer particles, wherein the bead of precursor composition is thereby reduced to a final thickness substantially equal to the diameter of the spacer particles; e) curing the bead of precursor composition to form a cured silicone barrier surrounding the opening or structure, wherein the silicone barrier is disposed between the wheel rim and the wheel cover; and f) providing a foaming composition in the gap between the wheel cover and the wheel rim, wherein the foaming composition reacts to form a foam adhesive layer within the gap, and wherein the cured silicone barrier effectively prevents expansion of the foam into or adjacent the opening or structure that is surrounded by the cured silicone barrier.

### BRIEF DESCRIPTION OF THE DRAWINGS

FIG. 1 is a schematic cross-sectional view showing a wheel cover bonded to a wheel rim via an adhesive layer having spacer particles according to the invention.

FIG. 2 is a side view of a motorcycle wheel having a motorcycle wheel rim and a tire mounted to the rum.

FIG. 3 is a perspective view showing a motorcycle wheel rim and a matching wheel cover lined up for assembly, but before the wheel cover is attached to the wheel rim.

FIG. 4 is a cross-sectional view taken along line 4-4 in FIG. 2.

FIG. 5 is a side view of a passenger vehicle wheel having a passenger vehicle wheel rim with a wheel cover adhered thereto.

FIG. 6 is a perspective view showing a passenger vehicle wheel having a passenger vehicle rim and a tire mounted thereto, and a wheel cover lined up for assembly to the rim, but before the wheel cover is attached to the rim.

FIG. 7 is a cross-sectional view of a passenger vehicle rim with a wheel cover applied thereto according to the invention.

FIG. 8 is an enlarged view of the portion indicated by the arrowed circle 8 in FIG. 7, showing the wheel cover, the passenger vehicle rim and the adhesive layer therebetween, the adhesive layer having spacer particles according to the invention.

FIG. 9 is a side view of a passenger vehicle rim illustrating a preferred pattern for applying the uncured precursor composition for the adhesive layer according to the invention.

### DETAILED DESCRIPTION OF THE PREFERRED EMBODIMENTS OF THE INVENTION

As used herein, when a range such as 5-25 is given, this means preferably at least 5 and, separately and independently, preferably not more than 25.

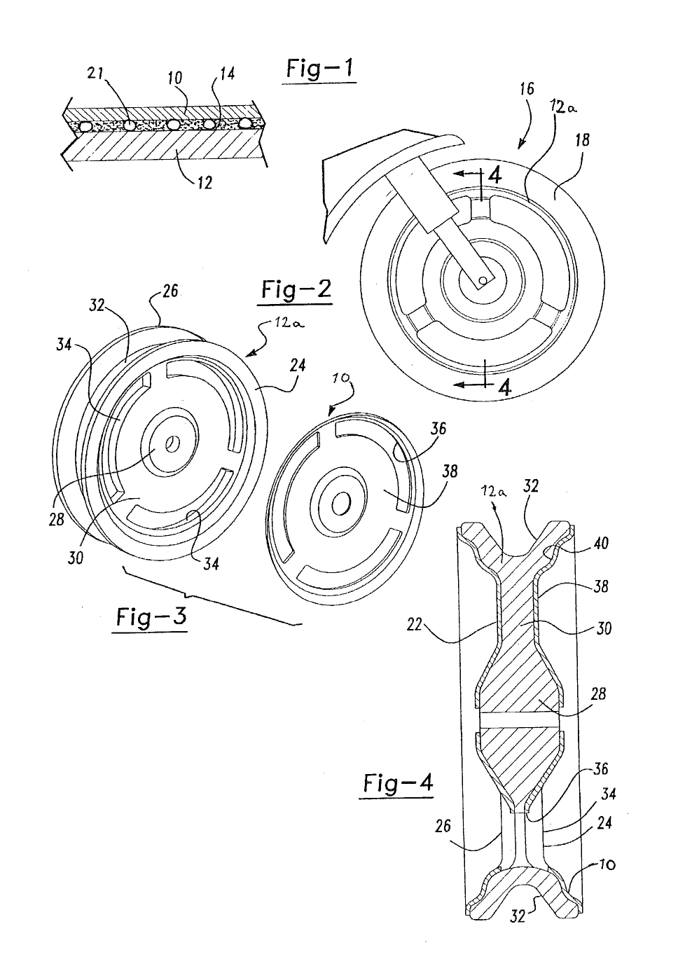

As seen in FIG. 1, a wheel cover 10 is applied to a wheel rim 12 using a bonding material or cured adhesive layer 14, which is preferably based on a silicone-containing material, and more preferably an oxime silicone rubber-containing material. The adhesive layer 14 has spacer particles 21 dispersed throughout the layer to ensure that the adhesive layer has the appropriate uniform layer thickness as will be described in detail below. The adhesive layer 14 preferably has good flexibility characteristics, gap filling ability, shock and heat resistance, the ability to avoid embrittlement or other adverse effects of thermal cycling, and the ability to set up and cure without fixturing or otherwise mechanically retaining the wheel cover 10 and rim 12 in place. The adhesive layer material is preferably applied as an uncured silicone precursor composition that cures in-situ once the wheel cover 10 has been press-fitted to the rim 12. The uncured precursor composition, the resulting adhesive layer, and the method of attachment are described in more detail below. In a preferred embodiment, when the wheel cover 10 is applied to a wheel rim 12, the above-described features of the bonding material allow the wheel cover to be applied to a standard wheel rim and to meet the desired performance characteristics. Thus, the resulting adhesive layer will withstand the loads encountered by a wheel and its associated wheel cover under normal service conditions and still exhibit a high integrity bond.

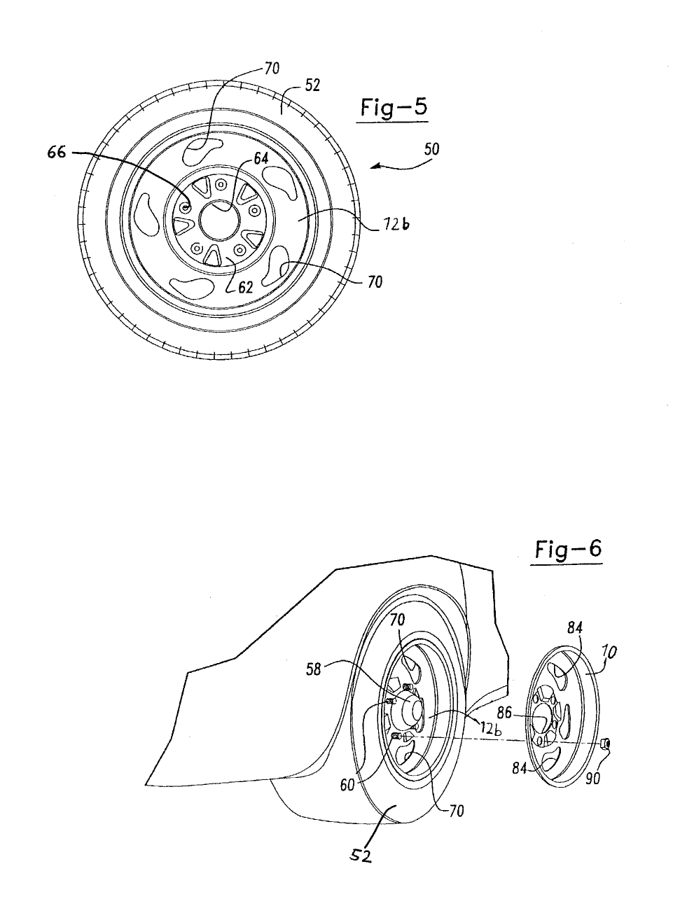

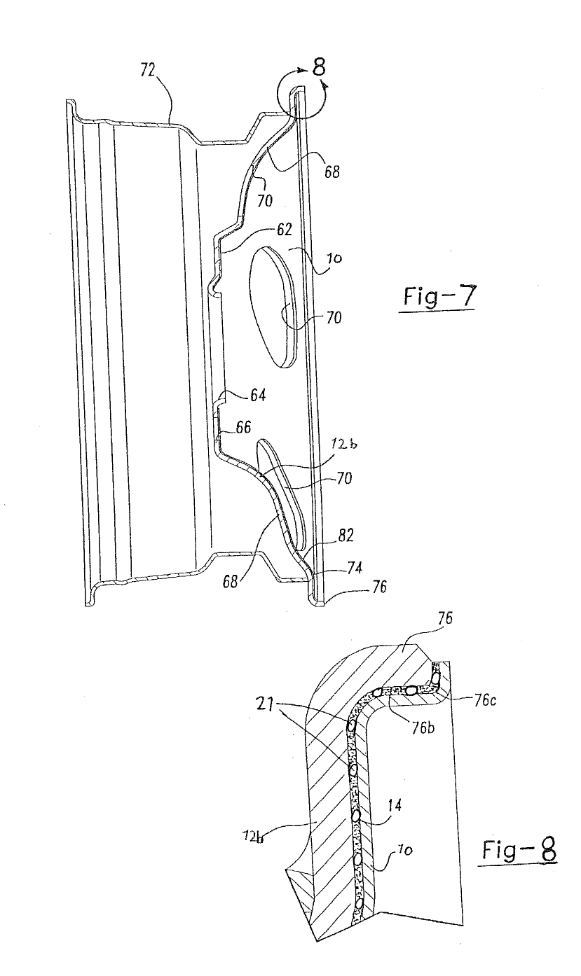

FIGS. 2-4 illustrate a wheel cover 10 applied to a motorcycle wheel rim while FIGS. 5-8 illustrate a wheel cover 10 applied to a passenger vehicle wheel rim. With references to FIGS. 2-4, a motorcycle wheel 16 includes a tire 18 and a motorcycle wheel rim 12a. A chrome plated wheel cover 10 is applied to each of the opposing faces 24, 26 of the rim 12a. Rim 12a is provided with a central hub portion 28, a spoke portion 30 extending radially from hub 28, and a wheel well portion 32 extending from spoke portion 30. Spoke portion 30 can be provided with openings 34 or can be provided with a solid configuration. It should be noted that the rim 12a can have a generally standard rim configuration as sold by motorcycle manufacturers. Alternatively, the rim 12a can be a custom rim.

The wheel cover 10 preferably has a configuration substantially conforming to the shape and contour of each opposing face 24, 26 of rim the rim 12a. In particular, if rim 12a is provided with openings such as openings 34, the wheel cover 10 is provided with corresponding openings 36 that are substantially in register with openings 34 when the wheel cover is applied to the rim. The wheel cover 10 is preferably a stamped sheet metal member having a chrome plated front face 38 and a rear face 40. The rear face 40 preferably has a shape and a surface contour complementary to that of the face 24 or 26 of rim 12a to which the wheel cover 10 is to be applied. In one embodiment, the wheel cover 10 comprises only a ring or sectional portion for covering a corresponding portion of the rim 12a, leaving the remainder, or uncovered portion, of the rim 12a exposed.

Referring now to FIGS. 5-8, a passenger vehicle wheel 50 is shown having a tire 52 and a passenger vehicle rim 12b. The wheel cover 10 is applied to rim 12b according to the principles of the present invention. Rim 12b is assembled to a wheel mount hub 58 provided with a plurality of threaded lugs 60 to mate with lug nuts 90. A central hub portion 62 of rim 12b is provided with an opening 64 for receiving wheel mount hub 58. Central hub portion 62 is provided with a plurality of lug holes 66 for receiving threaded lugs 60. A spoke portion 68 extends radially from central hub portion 62. Openings 70 generally are provided in spoke portion 68 for aesthetic and cooling purposes. In particular, openings 70 allow cooling air to pass through rim 12b in order to cool the brake assembly typically disposed behind rim 12b. An example of one shape for the openings 70 is depicted in FIG. 5, but is not intended as limiting. A wheel well portion 72 is attached to the radially outer portion 74 of spoke portion 68. The corresponding wheel cover 10 has openings 84 corresponding to the openings 70 in the rim 12, and also a central hub opening 86 to accommodate the wheel hub 58 therein. The above description of the passenger vehicle wheel rim 12b is intended to describe a standard passenger vehicle rim, such as cast aluminum, stamped full face wheel (aluminum or steel) and spider and rim type designs. It will be understood that other wheel rim configurations are possible, and can be used with the present invention. The only requirement is that the wheel cover 10 be configured to “match” the particular wheel rim (i.e. shape, contour, etc.) to which it will be attached or applied as further described below.

Motor cycle wheels 16 and passenger wheels 50 are described separately above only to illustrate that the invention can be used with both types of wheels, even though their respective wheel rims are configured differently. As used below, the term “rim” or “rim 12” shall embrace both the motorcycle wheel rim 12a and the passenger vehicle wheel rim 12b described above. As used in the claims, the term “rim” shall likewise be construed to embrace both a motorcycle wheel rim and a passenger vehicle wheel rim.

The wheel cover 10 is applied to rim 12 via adhesive layer 14. No mechanical attachment means or fixturing of the wheel cover 10 to the rim 12 is required.

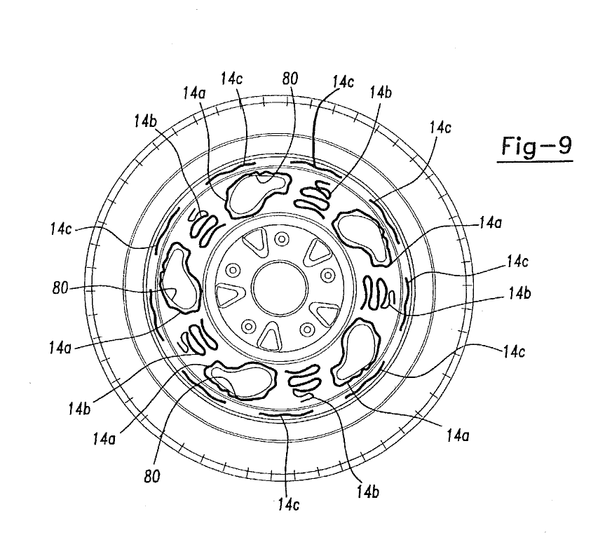

The wheel cover 10 is preferably made from metal, such as aluminum or steel. Alternatively the wheel cover 10 can be made from plastic. The wheel cover 10 is preferably provided with a nickel-chrome plated outer face to simulate a chrome or chrome plated wheel. Alternatively, the wheel cover may be provided with any desired decorative pattern or indicia on its outer face, e.g., it can be painted, rough sanded, circular or pattern sanded, pitted, etched, etc. The uncured precursor composition for the adhesive layer 14 can be applied to either the rear face of the wheel cover 10 or the outboard surface of the rim 12. As shown in FIG. 9, the uncured precursor composition is preferably provided in a bead around a periphery of any openings (shown at 14a), between the openings (shown at 14b), and intermittently around a radially outer surface of the rim or wheel cover (shown at 14c). The uncured precursor composition is preferably applied in a bead having a width of about 6-7 mm. A suitable dispensing device, such as a caulk gun, a syringe-like container or a squeezable dispensing tube can be employed to dispense the uncured precursor composition onto the rear face of the wheel cover 10 or the outboard surface of the rim 12.

If the wheel cover 10 is to be applied to an aluminum rim (or between dissimilar metals in general), the uncured precursor composition can be used as a coating between the wheel cover 10 and the rim 12 in order to help prevent galvanic corrosion between the dissimilar metals. In this case preferably the entire rear face of the wheel cover 10 or the outboard surface of the aluminum rim 12 is coated with the uncured precursor composition so that the resulting adhesive layer 14 will act as an interpositional layer separating the rim 12 from the wheel cover 10. In this embodiment, a coating of the uncured precursor composition is applied to the outboard surface of the rim 12 or the rear face of the wheel cover 10 that is preferably at least 0.04, 0.05, 0.06, 0.07, 0.08, 0.09, or 0.1, inches thick. A suitable applicator, such as a rubber spatula, can be used to apply and spread this layer to the desired thickness stated above. Then the wheel cover 10 is applied and press-fit to the outboard surface of the rim 12, and excess uncured precursor composition is squeezed out as explained in detail below until the desired final thickness for the adhesive layer 14 is achieved.

In one embodiment, a kit is provided for use by an applicator of the wheel cover to a rim. The kit preferably contains the uncured precursor composition for forming the adhesive layer and the wheel cover. The kit can also include one or more of the following: wheel rim, lug nuts, cleaner for preparing the surface of the rim, an applicator for the rim surface cleaner, and cleaner for the decorative surface of the wheel cover, among other components. Such other components include a wheel lock, emblems, applicator spatula, etc. The kit may be assembled or provided in any suitable package, and can be sold or offered for sale by or to retailers and wholesalers of automobile parts, to after-market consumers, auto dealerships, OEMs, etc.

The adhesive layer 14 is provided by in-situ curing of the uncured precursor composition as described above. Preferably, the uncured precursor composition is a suitable silicone composition as known in the art. The uncured precursor composition is preferably a single component, moisture-cured oxime silicone precursor composition, preferably an oxime silicone rubber material. The uncured precursor composition preferably has high green strength, meaning that once compressed to its final thickness, the precursor composition layer (sandwiched between the rim 12 and the wheel cover 10) has sufficient adhesive strength to retain the wheel cover 10 in place on the rim 12 with no or substantially no slippage until the composition has fully cured to yield the adhesive layer 14.

The principle ingredient of the silicone precursor composition may be represented by the structural formulas (1) and/or (2) below. It is a linear polyorganosiloxane, which is terminated on each end with oxime functionality and where R₁ and R₂ are organo groups including alkyls such as methyl, ethyl, etc., or aryls such as benzyl or phenyl, or halogenated alkyls such as 3,3,3-trifluoropropyl.

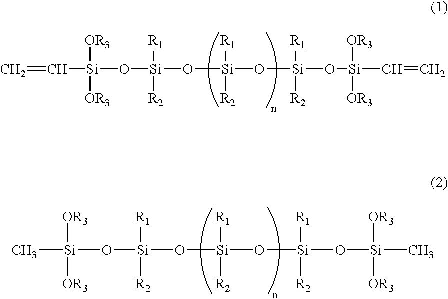

The silicone oligomers of formulas (1) and (2) above are the reaction product of silanol terminated polyorganosiloxanes of formula (3) where R₁ and R₂ are as defined above and silane coupling agents of formulas (4) and (5) in the presence of a condensation catalyst such as an organotin derivatives.

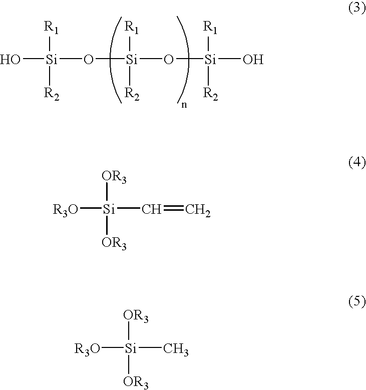

In formulas (1) through (5) above, R₃ is an oxime group having the following preferred structure:

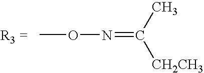

It is preferred that R₁ and R₂ be alkyl groups, most preferably methyl. The degree of polymerization represented by n in formula (1) is preferably be greater than 50 to achieve the desired properties. There is no upper limit for the degree of polymerization, n. Preferably, n is not more than about 1500. The molecular weight of the polyorganosiloxane determines its viscosity as well as the ultimate physical properties and other cure characteristics of the final composition. Depending on the desired physical properties, silanol terminated silicone polymers with viscosity in the range from 100 cps to 50,000 cps can be employed. Preferably, the viscosity is 20,000-50,000 cps for sealant and adhesive compounds used in the present invention.

The precursor composition may optionally include other ingredients that do not interfere with the moisture-activated curing mechanisms. Such optional ingredients include fillers, both reinforcing and semi-reinforcing varieties that are used to modify the rheology, improve the final physical properties (i.e., hardness, tensile strength, etc.) and reduce the cost. Suitable fillers may be selected from a long list of materials that are known to those skilled in the art such as, silica, talc, calcium carbonate among others. Further examples of acceptable fillers may be found in U.S. Pat. No. 4,072,635. Other ingredients include, but are not limited to the following: adhesion promoters, such as tris-[3-(trimethoxysilyl)propyl] isocyanurate, or 2,3-epoxypropyl silane; plasticizers such as, alkylbenzene derivatives, or trimethylsilyl terminated polyorganosiloxanes; pigments; stabilizers or other compounding aids as necessary to achieve the required product characteristics.

Preferably, the silicone precursor composition is Novagard RTV 400-118, or Novagard RTV 400-590 which are both silicone sealants/adhesives that are available from Foamseal/Novagard, Cleveland, Ohio. Both of the aforementioned Novagard products are single-component, moisture-cured, oxime silicone sealants which have the general physical characteristics as outlined in Table 1.

TABLE 1
Physical properties of preferred moisture-cured oxime silicone sealant

| Physical Property | Test Method/Conditions | Specification |
|---|---|---|
| Extrusion Rate | See following paragraph | 40 gm/min minimum |
| Slump (Flow) | ASTM D 2202 | 0.3” maximum |
| Tack Free Time | ⅜” @ 50% RH & 77 F. | 5-15 minutes |
| Through Cure | ⅛” @ 50% RH & 77 F. | 6-24 hours |
| Specific Gravity | See following paragraph | 1.00-1.30 |
| Shore Hardness | ASTM D 2240 | 20-50 |
| Tensile Strength | ASTM D 412 | 200-500 psi |
| Elongation | ASTM D 412 | 200-600% |

The extrusion rate reported in table 1 above is the rate in g/min that the preferred moisture-cured oxime silicone sealant is extruded from a nozzle having an orifice ID of 0.125±0.01 inch using air at a pressure of 40±2 psig to supply the extrusion force. The test was conducted by extruding the silicone into a tared container for 20 seconds, weighing the extruded silicone and multiplying the weight in grams by 3 to get grams/minute. The specific gravity reported in table 1 was obtained by weighing an 83.2 mL sample of the silicone on a gram-balance (resolution of at least 0.1 grams). Specific gravity=mass in grams/83.2 mL.

Other examples of acceptable silicone precursor compositions include: Loctite® 5900 sold by Loctite Corporation, Rocky Hill, Conn. which is an oxime-cured silicone flange sealant similar to Novaflex RTV 400-590, and Dow Corning® 3-0115 Automotive Sealant sold by Dow Coming, Midland, Mich. which is a one-part, self-priming, noncorrosive, alkoxy-cure silicone rubber.

Still other materials can be used to provide the adhesive layer 14, e.g., curable silicones, sealants and other polymeric agents capable of in-situ curing; e.g. acrylic polymers, urethane polymers, and sulfide polymers. The adhesive layer 14 can be a latex layer as is well known in the art.

In accordance with the present invention, the uncured precursor composition for the adhesive layer 14 has a quantity of spacer particles of substantially uniform diameter uniformly dispersed therein. The spacer particles are provided to facilitate the desired final thickness of the precursor composition layer between the wheel cover 10 and rim 12, and therefore of the adhesive layer 14. The method of applying the wheel cover according to the invention will now be described.

First, the wheel cover is provided. The wheel cover preferably has a surface contour that is complementary to the portion of the wheel rim 12 to which it will be applied as explained above. Next, a quantity of the precursor composition is applied to either the wheel rim 12 outboard surface or the wheel cover 10 rear face. For purposes of this description, it is assumed that the uncured precursor composition is applied to the rear face of wheel cover 10. Once the uncured precursor composition is applied, the wheel cover 10 is applied and press-fit to the complementary outboard surface portion of the wheel rim 12 with suitable pressure. The spacer particles 21 present in the uncured precursor composition have a diameter that is substantially equal to the desired thickness of the fully cured adhesive layer 14. Thus, as the wheel cover 10 is pressed (by external pressure) against the wheel rim 12 (with the uncured precursor composition in between) the gap between the wheel cover 10 and the rim 12 is uniformly reduced to the diameter of the spacer particles 21 with excess uncured precursor composition being squeezed out (see FIG. 1).

The spacer particles prohibit or inhibit squeezing out too much of the precursor composition because the particles 21 prevent closure of the gap between the wheel cover 10 and the rim 12 to less than the diameter of the particles. Accordingly, the layperson can apply excess pressure over the entire outer surface of the wheel cover 10 and a uniform gap of constant thickness is assured by the spacer particles 21. That the layperson may apply relatively more or less pressure at one or more points over the wheel cover surface is made immaterial by the present invention because the spacer particles 21 ensure a uniform gap (adhesive layer 14) thickness so long as at least enough pressure is exerted to compress the gap down to the diameter of the spacer particles 21. In other words, excess pressure, even non-uniform excess pressure, above that required to compress the uncured precursor composition to the final thickness (equal to the spacer particle diameter) can be applied and will still result in a uniform adhesive layer 14 once the precursor composition is cured.

In addition, by preventing too much of the uncured composition from being squeezed out of the gap between the wheel cover 10 and the rim 12, less of the uncured composition is necessary to ensure comparable adhesive performance of the resulting adhesive layer 14. This means that in both lay-application as well as automated application, finer beads (i.e. a small amount) of the uncured precursor composition according to the invention need be applied to provide an effective adhesive layer 14 than the corresponding or otherwise conventional amount of existing precursor compositions that do not contain spacer particles.

The spacer particles 21 thus eliminate or substantially eliminate problems associated with nonuniform adhesive layer thickness in both lay- and automated applications; the wheel cover 10 is simply compressed to the wheel rim 12 over its entire surface until further compression is prevented or inhibited due to the presence of the spacer particles 21 (see FIG. 1). The result is that when the precursor composition cures, the adhesive layer 14 will be a continuous adhesive layer having a constant and uniform layer thickness throughout that is substantially equal to the diameter of the spacer particles 21. The continued presence of the spacer particles 21 does not substantially negatively affect the bond strength of the adhesive layer because they are provided in a small enough quantity as to have practically no or minimal effect once the adhesive layer is fully cured.

The spacer particles 21 should be of uniform size within a range of about 0.01 inch to about 0.125 inch in diameter, preferably 0.02-0.1, preferably 0.025-0.05, preferably about 0.03, inches in diameter. This will result in an adhesive layer 14 having a corresponding adhesive layer thickness, preferably about 0.03 inches.

The spacer particles must be thoroughly mixed into the uncured precursor composition. The viscosity of the precursor composition keeps the particles 21 in suspension during storage and dispensation of the composition, until the composition is fully cured to provide the adhesive layer 14 of the present invention. In a preferred embodiment, the specific gravity of the spacer particles is equal to, or substantially equal to the specific gravity of the uncured precursor composition to minimize or eliminate buoyant effects such as floating or settling and to promote a substantially uniform suspension of the spacer particles in the uncured precursor composition.

To ensure substantially uniform particle diameter, the spacer particles 21 can be sieved as known in the art. Preferably, the particles in the uncured precursor composition do not vary significantly in diameter; i.e. the spacer particles 21 preferably have a particle size distribution not more than 0.02 inch, preferably not more than 0.015 inch, preferably not more than about 0.01 inch.

When the precursor composition is moisture cured, as in the preferred oxime silicone composition, the rate of cure will depend on the (atmospheric) relative humidity and the thickness of the gap between the wheel rim 12 and the wheel cover 10. Higher humidity means higher cure rate and vice versa. Also, a smaller gap width results in a lower flux of ambient moisture into the uncured layer between the rim and the wheel cover, which in turn slows the cure rate. Hence, it is contemplated that larger spacer particles (providing a larger gap width) may be used when the invention is to be practiced in arid climates, whereas smaller particles may be used in more humid climates to promote fill adhesive layer cure within a reasonable or suitable time.

The preferred amount of spacer particles is about 3 grams of particles per 10 ounces of the uncured precursor composition, or about 1% by weight. This ratio preferably results in about one spacer particle per square inch of the adhesive layer 14 at its desired thickness. Less preferably, the spacer particles 21 are provided to the composition in a weight percent of 0.05-1.5, less preferably 0.04-1.8, less preferably 0.03-2, less preferably 0.02-2.5, less preferably 0.01-3, less preferably 0.01-4, less preferably 0.01-5, weight percent.

Alternatively, the weight percent of the spacer particles can be adjusted to provide a suitable adhesive layer 14 for a particular application; e.g., depending on the weight of the wheel cover 10, and the nature of the vehicle to which the wheel cover 10 will be applied (and therefore the likely stresses it will encounter—motorcycle vs. sports car vs. touring sedan, etc.). As the weight of the wheel cover 10 and/or the stress which it will undergo increase(s), it may be necessary to adjust the amount and/or size of the spacer particles to provide a thicker, more robust adhesive layer 14 between the wheel rim 12 and the wheel cover 10.

The amount of spacer particles 21 in the composition should be just enough to provide the desired gap thickness between the wheel cover 10 and the rim 12 and to prevent squeezing out too much of the composition when applying manual pressure to the wheel cover 10. When using automated equipment to provide the necessary pressure, the equipment should be adjusted to avoid providing excess pressure; i.e. the equipment should be adjusted so that the maximum force it will exert does not exceed the crush strength of the spacer particles (described below). Spacer particles in excess of what are necessary for this purpose can cause complications, such as settling out of the precursor composition during storage and interference with proper curing of the composition between the rim 12 and wheel cover 10. The spacer particles are preferably added at the end of the manufacturing process for the uncured precursor composition, which is preferably an in-situ curable silicone composition, preferably an oxime silicone composition as stated above.

In a preferred embodiment, the spacer particles 21 are 4A molecular sieve zeolite silica gel beads available from, e.g., Zeochem of Louisville, Ky. These beads typically are available in two size ranges, 0.5-1.0 mm and 1.0-2.0 mm. The typical average crush strength per bead for the 0.5-1.0 mm beads is 1.0 pound. The typical average crush strength per bead for the 1.0-2.0 mm beads is 4.0 pounds. Synthetic amorphous silica gel beads can also be used, which can be obtained from Zeolite. These beads have a typical average crush strength per bead of at least 12 pounds.

Less preferably, the spacer particles 21 can be polypropylene copolymers, e.g. manufactured by the SPHEROL process of Himont Incorporated, less preferably ethylene vinyl acetate particles and particles of other resins. Since the polymeric particles will tend to give and compress without fracturing they should be larger in diameter than 4A silica gel particles for the same application and this factor should be taken into consideration when determining particle sizes. When resin particles are used, their diameter is preferably 0.030 up to about 0.150 inches.

Other particles which may be used are some of the natural or artificial zeolites, activated alumina, and anhydrous calcium sulfate particles. The particles preferably are of substantially uniform diameter within the ranges given above. The nature of the particles is preferably such that they can be sorted or segregated by diameter into groups of particles having relatively small size distributions as disclosed above. Otherwise, nonuniformities in the thickness of the adhesive layer 14 may result. The hardness of the particles is preferably less than 4 on Moh's hardness scale.

The spacer particles 21 should have a crush strength sufficient to withstand being crushed under the influence of manual human pressure used to press the wheel cover 10 to the wheel rim. Preferably, the spacer particles 21 have an average crush strength of at least 1 pound per particle, preferably at least 2, preferably at least 3, preferably at least 4, preferably at least 5, pounds per particle, and can have an average crush strength up to about 10 to 15 pounds or more, or up to 20 pounds, per particle.

In addition to enhancing the performance and adhesion characteristics of lay-applied decorative wheel covers 10, the invention also has particular utility for automated assembly operations using automated equipment such as that utilized by OEMs. In an automated assembly process for applying decorative wheel covers 10 to wheel rims 12, the invented precursor composition having the spacer particles 21 dispersed therein can be applied to the rear face 40 of the wheel cover 10 (or to the outboard surface of the rim 12) in a very precisely controlled bead; e.g. having a bead diameter of less than ⅛ inch, preferably less than 3/16 inch, preferably less than 1/16 inch. The bead of uncured precursor composition can be advantageously applied, e.g. via automated equipment (including a nozzle or extruder head) in a desired pattern to the rear face 40, or outboard surface of the rim 12, or both. The spacer particles 21 uniformly dispersed in the uncured precursor composition facilitate deposition of a smaller, more precisely controlled amount of the precursor composition prior to press-fitting the wheel cover 10 to the wheel rim 12 because the spacer particles 21 ensure optimum thickness of the resulting adhesive layer 14 once cured. Therefore, excesses of uncured precursor composition, heretofore necessary or conventional in the prior art as a precaution against nonuniform layer thickness, are effectively eliminated by the present invention.

In a further preferred embodiment of the invention, when the adhesive layer is to be provided by an in-situ curing foam, silicone adhesives as described above (provided by the uncured precursor composition having the spacer particles 21) can act as a barrier to foaming as will now be described. When it is desired to use a foam layer as the adhesive layer 14, the problem of ensuring a uniformly thick fully cured foam adhesive layer is even more significant than for a silicone layer because curing foams expand as they cure. The present invention can be advantageously applied to solve this problem as follows. A bead of the uncured silicone precursor composition can be applied to the outboard surface of the rim 12 (e.g. as shown in FIG. 9), or to the complementary rear face 40 of the wheel cover 10 surrounding through openings or other structures into or adjacent to which foam expansion is not desired. The beads shown at 14a in FIG. 9 would be desired in this application. Once these beads of precursor composition are applied, the wheel cover 10 is press-fit to the wheel rim 12 as described above and the precursor composition is allowed to cure. Once cured, the resulting beads of cured silicone adhesive result in a barrier to foaming that will prevent foam expansion into or adjacent to the surrounded openings or structures. Simultaneously, the gap between the rim 12 and the wheel cover 10 has a substantially uniform thickness approximately equal to the diameter of the spacer particles 21. Subsequently, the foam components (polyol and isocyanate) can be injected into this gap and reacted or foamed to provide the desired foam adhesive layer. The beads of the silicone adhesive retain the rim 12 and wheel cover 10 together against the expansive pressure of the foaming layer, while at the same time presenting a barrier to foaming into or adjacent to the enclosed openings or other structures. In this application, the uncured precursor composition is preferably applied to the rear face 40 of the wheel cover 10 in beads surrounding any through openings 84, as well as any central hub opening 86. (See FIG. 6).

Although the hereinabove described embodiments of the invention constitute the preferred embodiments, it should be understood that modifications can be made thereto without departing from the scope of the invention as set forth in the appended claims.

What is claimed is:

1. A method of applying a decorative wheel cover to a wheel rim, comprising the steps of:
a) providing an uncured precursor composition, said precursor composition having a quantity of spacer particles dispersed therein;
b) applying said precursor composition to a rear face of said wheel cover or to an outboard surface of said wheel rim, or both;
c) applying said wheel cover to said wheel rim such that a layer of said precursor composition is sandwiched in a gap between said wheel cover and said wheel rim;
d) press-fitting said wheel cover to said wheel rim until said gap therebetween is reduced to substantially the diameter of said spacer particles, said precursor composition layer thereby being reduced to a final thickness substantially equal to the diameter of said spacer particles; and
e) curing said precursor composition layer to form a cured adhesive layer disposed between said wheel rim and said wheel cover.

2. A method according to claim 1, said cured adhesive layer having a substantially uniform thickness that is substantially equal to the diameter of said spacer particles.

3. A method according to claim 1, wherein further reduction of said gap in step (d) is inhibited by the presence of said spacer particles.

4. A method according to claim 1, said rear face of said wheel cover having a surface contour that is complementary to a surface contour of at least a portion of said outboard surface of said wheel rim.

5. A method according to claim 1, said wheel cover having a configuration substantially conforming to the shape and contour of said outboard surface of said wheel rim.

6. A method according to claim 5, said wheel rim having a plurality of openings therein, said wheel rim being provided with corresponding openings that are substantially in register with said openings in said wheel rim when the wheel cover is applied to said wheel rim.

7. A method according to claim 1, said adhesive layer comprising a silicone material, said precursor composition being moisture-cured and comprising a silicone material.

8. A method according to claim 7, said adhesive layer comprising oxime silicone rubber, said precursor composition being a single component, moisture-cured composition that comprises oxime silicone.

9. A method according to claim 1, said precursor composition having sufficient green strength to retain said wheel cover on said wheel rim following said press-fitting step until said precursor composition has fully cured to form said adhesive layer.

10. A method according to claim 1, said precursor composition having a viscosity of 20,000-50,000 cps.

11. A method according to claim 1, said precursor composition having a through cure time of about 24 hours or less for a layer that is ⅜ inch thick at 50% R.H. and 77° F.

12. A method according to claim 1, said spacer particles having a particle diameter of about 0.01 inch to about 0.125 inch.

13. A method according to claim 12, said spacer particles having a particle diameter of 0.02-0.1 inch.

14. A method according to claim 12, said spacer particles having a particle diameter of about 0.03 inches.

15. A method according to claim 1, said spacer particles having a specific gravity substantially equal to the specific gravity of said uncured precursor composition.

16. A method according to claim 1, said spacer particles having a particle size distribution not more than 0.02 inch.

17. A method according to claim 1, said precursor composition comprising 0.01-5 weight percent spacer particles.

18. A method according to claim 1, said precursor composition comprising a weight percent of spacer particles that is adjusted to accommodate the weight of said wheel cover and/or the stresses that said wheel cover will encounter.

19. A method according to claim 1, said precursor composition layer having about one spacer particle per square inch of said precursor composition layer at said final thickness thereof, said cured adhesive layer correspondingly having about one spacer particle per square inch thereof.

20. A method according to claim 1, said spacer particles being selected from the group consisting of silica gel beads, polypropylene copolymer particles, ethylene vinyl acetate particles and particles of other resins.

21. A method according to claim 1, said wheel cover being made from metal or plastic.

22. A method according to claim 1, wherein at least one of said steps (b), (c) and (d) is performed by automated equipment.

23. A kit comprising a decorative wheel cover and an uncured precursor composition, said decorative wheel cover being adapted to be applied to a wheel rim, said uncured precursor composition having a quantity of spacer particles dispersed therein, said uncured precursor composition being curable to form a cured adhesive layer between said decorative wheel cover and said wheel rim, said cured adhesive layer being effective to retain said wheel cover on said wheel rim.

24. A kit according to claim 23, further comprising said wheel rim.

25. A kit according to claim 23, said uncured precursor composition being a moisture-cured precursor composition.

26. A kit according to claim 23, said cured adhesive layer comprising silicone, said uncured precursor composition being a moisture-cured composition that comprises silicone.

27. A kit according to claim 26, said adhesive layer comprising an oxime silicone material, said uncured precursor composition comprising an oxime silicone material.

28. A kit according to claim 23, said spacer particles having a particle diameter of about 0.01 inch to about 0.125 inch.

29. A kit according to claim 23, said spacer particles having a particle diameter of 0.02-0.1 inch.

30. A kit according to claim 23, said spacer particles having a particle diameter of about 0.03 inches.

31. A kit according to claim 23, said spacer particles having a specific gravity substantially equal to the specific gravity of said uncured precursor composition.

32. A kit according to claim 23, said spacer particles having a particle size distribution not more than 0.02 inch.

33. A kit according to claim 23, said uncured precursor composition having 0.01-5 weight percent spacer particles.

34. A kit according to claim 23, said spacer particles being selected from the group consisting of silica gel beads, polypropylene copolymer particles, ethylene vinyl acetate particles and particles of other resins.

35. A kit according to claim 23, said uncured precursor composition being provided in a squeezable tube.

36. An automobile wheel comprising a wheel rim and a decorative wheel cover adhered to said wheel rim via a cured adhesive layer disposed therebetween, said cured adhesive layer having a quantity of spacer particles therein, said adhesive layer having an adhesive layer thickness that is substantially equal to a diameter of said spacer particles.

37. An automobile wheel according to claim 36, said adhesive layer thickness being substantially uniform throughout said cured adhesive layer.

38. An automobile wheel according to claim 36, said spacer particles having a particle diameter of about 0.01 inch to about 0.125 and a particle size distribution not more than 0.02 inch.

39. A method of applying a decorative wheel cover to a wheel rim via a foam adhesive layer, comprising the steps of:
a) providing an uncured silicone precursor composition, said precursor composition having a quantity of spacer particles dispersed therein;
b) applying said precursor composition to a rear face of said wheel cover or to an outboard surface of said wheel rim, or both, said precursor composition being applied in a bead surrounding an opening or structure into or adjacent to which foam expansion is to be avoided;
c) applying said wheel cover to said wheel rim such that said bead of precursor composition is sandwiched in a gap between said wheel cover and said wheel rim;
d) press-fitting said wheel cover to said wheel rim until said gap therebetween is reduced to substantially the diameter of said spacer particles, said bead of precursor composition thereby being reduced to a final thickness substantially equal to the diameter of said spacer particles;
e) curing said bead of precursor composition to form a cured silicone barrier surrounding said opening or structure, said silicone barrier being disposed between said wheel rim and said wheel cover; and
f) providing a foaming composition in said gap between said wheel cover and said wheel rim, wherein said foaming composition reacts to form a foam adhesive layer within said gap, said cured silicone barrier effectively preventing expansion of said foam into or adjacent said opening or structure that is surrounded by said cured silicone barrier.
